(19) United States
(12) Patent Application Publication
(10) Pub. No.: US 2003/0113615 A1
(43) Pub. Date: Jun. 19, 2003

(54) Recombinator for the re-acidification of an electrolyte stream in a flowing electrolyte zinc-bromine battery

(76) Inventor: Gerd Tomazic, Murzzuschlag (AT)

Correspondence Address: FACTOR & PARTNERS, LLC, 1327 W. WASHINGTON BLVD., SUITE 5G/H, CHICAGO, IL, 60607, US

(21) Appl. No.: 10/017,918

(22) Filed: Dec. 13, 2001

(51) Int. Cl. H01M 2/40; H01M 10/50; H01M 10/52; H01M 8/18

(52) U.S. Cl. 429/70; 429/105; 429/53; 429/51; 429/62

(57) ABSTRACT

The present invention is directed to a recombinator and a method for using a recombinator, wherein the recombinator comprises a housing operatively associated with a zinc-bromine battery, wherein the housing comprises an outer wall that defines a reaction space therein, means for introducing hydrogen into the reaction space from the zinc-bromine battery, means for introducing bromine into the reaction space from the zinc-bromine battery, means for controlling the delivery of bromine into the reaction space, wherein the delivery control means comprises at least one flow channel associated with the inner surface of the outer wall, means for reacting the hydrogen and the bromine together so as to form hydrobromic acid; and means for distributing the hydrobromic acid back into the zinc-bromine battery for the reacidification of same.

### BACKGROUND OF THE INVENTION

1. Field of the invention

The present invention relates in general to zinc-bromine battery systems, and, more particularly, to a device and method for the re-acidification of an electrolyte stream in a zinc-bromine flowing electrolyte battery.

2. Background Art

The original concept of utilizing the properties of zinc and bromine in a battery system was patented over 100 years ago in U.S. Pat. No. 312,802. Generally, the battery system has a negative flow loop and a positive flow loop, as well as a separator of some kind in-between. The zinc-bromine electrolyte is circulated through both loops, depositing zinc at the negative electrode, and creating aqueous bromine at the positive electrode, all while creating a voltage difference between the two electrodes. The zinc is collected as a solid, while the aqueous bromine forms a second liquid phase and is separated from the flowing electrolyte.

Utilizing a circulating electrolyte system, Zinc-Bromine batteries have significant advantages, including ease of thermal management and uniformity of reactant due to electrolyte flow, operation of the system at ambient temperature, rapid system charging, complete system discharging, good specific energy of reactants, and a system that is generally constructed from low-cost and readily available materials. The system did not gain immediate commercial acceptance, however, due to the formation of zinc dendrites upon deposition of zinc at the negative electrode, impeding the flow of electrolyte, and due to the solubility of bromine in the zinc-bromine electrolyte, causing a cell short circuit.

In the 1970s, Exxon Corp. and Gould Inc. developed techniques that attempted to inhibit the formation of zinc dendrites upon deposition at the negative electrode. Upon operation, the cell could now be operated for significantly longer periods of time without the previous inhibited flow. The zinc-bromine battery was now a commercially reasonable means of storing and recovering power. However, current operation of zinc-bromine batteries still contain significant problems.

Current operation of a zinc-bromine cell requires specific parameters for continuous operation. Among these requirements is one that the system be operated at or near a pH of two. This requirement exists because at higher pH levels mossy zinc plating develops, as well as bromates within the electrolyte solution. Alternatively, at lower pH values, zinc corrodes at an increasing rate. Although the system reactions do not themselves affect pH, overcharging of the cell during cyclical operation may electrolyze water, creating gaseous hydrogen and hydroxide ions in the water, raising the pH.

Therefore, it is an object of this invention to create a device and method for the re-acidification of the zinc-bromine electrolyte stream in a flowing electrolyte system to, in turn, facilitate longer and more efficient continuous operation of the battery.

It is a further object of this invention to create a means for re-acidification utilizing the products of the current battery system so that an ongoing and steady-state system may be developed.

It is also an object of this invention to create a device for use with a zinc-bromine battery system that reacidifies the electrolyte stream, while maintaining system conditions, and upon failure of the system conditions, a device that will quickly and safely correct the conditions to secure battery operability.

These and other objects will become apparent in view of the present specification, claims and drawings.

### SUMMARY OF THE INVENTION

The present invention is directed to a recombinator, comprising a housing operatively associated with a zinc-bromine battery, wherein the housing comprises an outer wall that defines a reaction space therein, means for introducing hydrogen into the reaction space from the zinc-bromine battery, means for introducing bromine into the reaction space from the zinc-bromine battery, means for controlling the delivery of bromine into the reaction space, wherein the delivery control means comprises at least one flow channel associated with the inner surface of the outer wall, means for reacting the hydrogen and the bromine together so as to form hydrobromic acid, and means for distributing the hydrobromic acid back into the zinc-bromine battery for reacidification of same. Preferably, the at least one flow channel comprises a helix around the circumference of the inner surface of the outer wall. It is also preferred that the distributing means comprise a gap associated with the housing. Further, it is preferred that the bromine receiving means comprises an inlet stream coupling operatively attached to the zinc-bromine battery. Additionally, the housing may further comprise a threaded flange, and a wall flange, and the inlet stream coupling then would preferably comprise a ring space formed by the region between the threaded flange and the wall flange.

Similarly, the hydrogen receiving means may comprise a gap associated with the housing, wherein the gap exposes the reaction space to a hydrogen-rich environment, or the hydrogen receiving means also comprises the inlet stream coupling as disclosed above.

In a preferred embodiment, the reacting means comprises a catalyst operatively placed within the reaction space. Further, the housing may additionally comprise a central chamber having a base flange, and the catalyst may placed around the central chamber, and on top of the base flange. Preferably, the catalyst comprises a platinized carbon cloth having an area of approximately 40 cm2.

In yet another preferred embodiment, the reacting means comprises a means for controlling the temperature within the housing, wherein the temperature control means may comprise a heating element in thermal contact with the reaction space. In that embodiment, the housing may additionally comprise a central chamber, wherein the heating element is placed within the central chamber, and the reaction space is defined between the central chamber and the inner surface of the outer wall.

The present invention also discloses a gas handling unit for use with a flowing-electrolyte zinc-bromine battery having a positive electrolyte loop, a negative electrolyte loop, and electrode stacks, comprising a sealed gas chamber, means for receiving hydrogen into the sealed gas chamber from one of the positive and the negative electrolyte loops, means for receiving bromine into the sealed gas chamber from one of the positive and the negative electrolyte loops, means for reacting at least a portion of the hydrogen and bromine into hydrogen bromide, means for maintaining gaseous products, including unreacted hydrogen, within the sealed gas chamber; and means for distributing the hydrogen bromide and the unreacted bromine back to at least one of the positive and the negative electrolyte loops for the reacidification of same. Preferably, the hydrogen receiving means comprises an inlet stream coupling associated with at least one of the positive and negative electrolyte loops. Further, the electrode stack preferably comprises a hydrogen accumulation reservoir, wherein the hydrogen receiving means comprises an inlet stream coupling associated with the hydrogen accumulation reservoir, and the bromine receiving means comprises an inlet stream coupling associated with at least one of the positive and negative electrolyte loops. Additionally, the maintaining means preferably comprises a means for relieving excess pressure within the gas handling unit, the gas handling unit additionally comprises means for containing liquid overflow, and the distributing means comprises a first conduit and a second conduit, wherein the first conduit provides a fluidic connection between the gas handling unit and the positive electrolyte loop, and the second conduit provides a fluidic connection between the gas handling unit and the negative electrolyte loop.

In a preferred embodiment, the reacting means comprises a recombinator in operatively associated with the inlet stream coupling, wherein the recombinator comprises a housing, wherein the housing comprises an outer wall that defines a reaction space therein, means for introducing hydrogen into the reaction space, means for introducing bromine into the reaction space, means for controlling the delivery of bromine into the reaction space, means for reacting the hydrogen and the bromine together so as to form hydrobromic acid, and means for distributing the hydrobromic acid into the gas handling unit for the reacidification of an electrolyte stream therein.

In another preferred embodiment, the pressure relief means comprises a pressure release valve, and a pressure sensor associated with the pressure release valve, such that upon the occurrence of a predetermined condition, the pressure sensor activates the pressure release valve, venting at least a portion of the gaseous contents within the gas handling unit. In this embodiment, the pressure relief means may additionally comprises a filter apparatus associated with the pressure release valve such that vented gaseous contents pass through the filter apparatus before being released from the gas handling unit. Preferably, the filter apparatus a zinc filter.

In yet another preferred embodiment, the overflow containing means comprises an overflow container associated with the gas handling unit, such that upon the occurrence of the predetermined condition, excess liquid contained within the gas handling unit is introduced into the overflow container for later disposal.

In still another preferred embodiment, the gas handling unit additionally comprises means for preventing the introduction of bromine into the second conduit, wherein the gas handling preventing means comprises the second conduit extending further into the sealed gas chamber relative to the first conduit.

The present invention is additionally directed to a method for re-acidifying an electrolyte in a flowing electrolyte zinc-bromine battery, comprising the steps of introducing hydrogen into a reaction chamber, introducing an electrolyte stream at least partially comprising aqueous bromine into the reaction chamber, controlling the delivery of the electrolyte stream into the reaction chamber in such a way so as to increase the residence time of the electrolyte stream within the reaction chamber, reacting the bromine with the hydrogen to create a reaction product, reintegrating the reaction product with at least one of an electrolyte stream or an electrolyte reservoir of the zinc-bromine batter for re-acidification of same. In this embodiment, the step of controlling preferably comprises the step of allowing the electrolyte stream to flow down and through at least one flow channel associated with the reaction chamber. Additionally, the step of reintegrating the reaction product further includes the step of removing the reaction produce and excess reactants through a gap in the reaction chamber. Further, the step of reacting the aqueous bromine and hydrogen preferably includes the step of associating the same with a catalyst. The method also may also include the step of regulating the temperature of the reaction chamber.

In a preferred method, the at least one flow channel comprises at least one flow channel in the shape of a helix.

In another preferred method, the step of regulating the temperature further includes the steps of pre-heating the reaction chamber, and maintaining the temperature within the reaction chamber, wherein the step of pre-heating preferably comprises the step of adjusting the temperature of the reaction chamber to between approximately 100 degrees Celsius and approximately 120 degrees Celsius; and the step of maintaining the temperature of the reaction chamber comprises the step of maintaining the temperature between approximately 100 degrees Celsius and approximately 120 degrees Celsius.

In a final preferred method, the catalyst comprises at least one of a platinized carbon cloth, and heat.

### DESCRIPTION OF THE DRAWINGS

FIG. 1 is a schematic view of the recombinator device of the invention; and

FIG. 2 is a schematic view of the gas handling unit of the invention.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

The present invention comprises a recombinator device 10 for use with a flowing electrolyte zinc-bromine battery system, gas handling unit 100 for use with a flowing electrolyte zinc-bromine battery system, and a method for re-acidifying an electrolyte stream in the zinc-bromine battery system. The devices and method described below provide a novel, simple and continuous means for prolonging the uninterrupted operation of a zinc-bromine battery system, while reducing the unwanted byproducts of the system reactions.

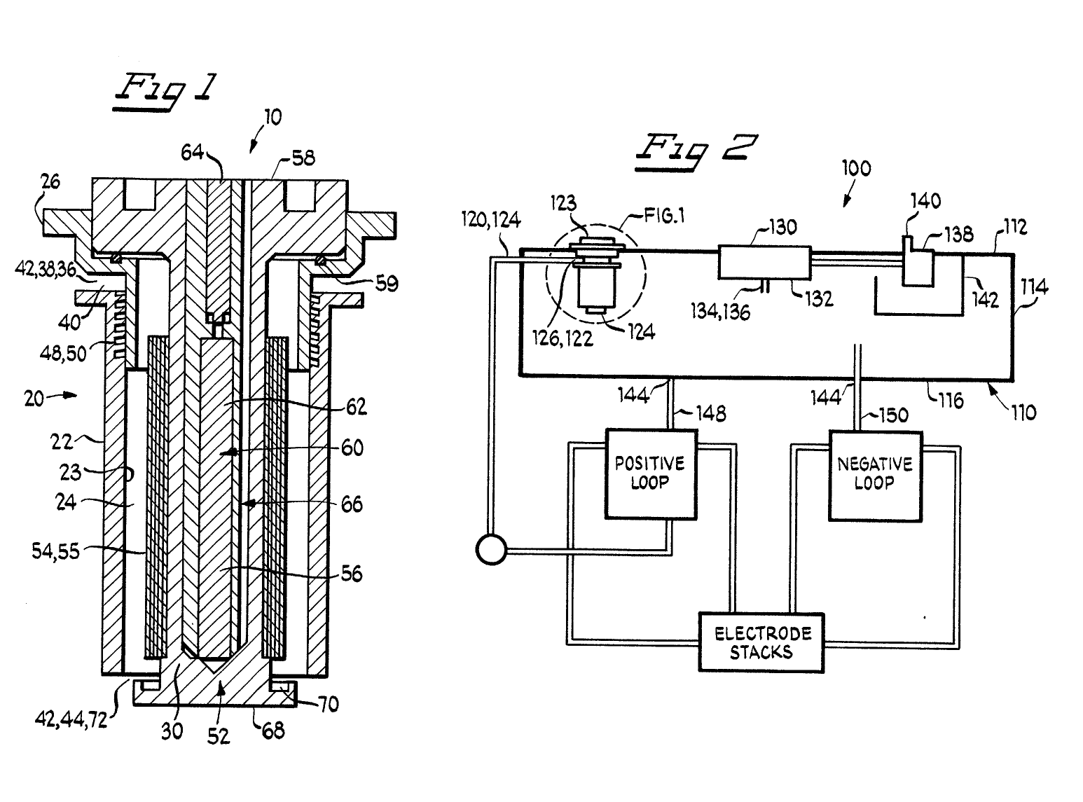

Specifically, and is shown in FIG. 1 of the drawings, recombinator device 10 comprises housing 20, bromine receiving means 36, hydrogen receiving means 42, delivery control means 48, reacting means 52, and distributing means 72. When in operation, recombinator device 10 is capable of receiving the secondary bromine phase from the positive loop of a zinc-bromine battery, vaporizing the bromine phase, and causing the vaporized bromine to react with hydrogen to form hydrogen bromide. Thereafter, the hydrogen bromide is returned to the electrolyte streams of the battery, reacidifying them, as well as removing unwanted hydrogen during the process.

Housing 20 is shown in FIG. 1 as comprising outer wall 22, reaction chamber 24, threaded flange 26, wall flange 28, central chamber 30 and base flange 68. Housing 20 is shown generally in a tubular or cylindrical shape, a shape that is selected in order to increase the uniformity of heating of outer wall 22 by heating element 58 (discussed below). However, another shape could similarly suffice, without deviating from the teachings of the invention.

Outer wall 22 helps to form the shape of housing 20. Outer wall 22 comprises the main portion of housing 20, and is a substantially uniform, rigid wall surrounding reaction chamber 24. Near the top portion of outer wall 22 is wall flange 28, extending perpendicularly outward from outer wall 22. As will be discussed further below, wall flange 28 enables the secure placement of recombinator device 10 within gas handling unit 100 (shown in FIG. 2).

Also associated with the top portion of outer wall 22 is threaded flange 26. Threaded flange 26 is shown as being associated with inner surface 23 of outer wall 22, having at least one flow channel 50 (discussed below) therebetween. Threaded flange 26 may be affixed in the specified location by conventional means, such as welding or adhesive, or may be removably affixed by the use of small threads to coincide with the at least one flow channel 50. However, if the use of small threads is employed, those small threads must leave at least some empty space within the at least one flow channel 50, as will be discussed below.

At the center of housing 20 is central chamber 30. Central chamber 30 is constructed from a rigid material capable of conducting heat, such as aluminum. Central chamber 30 is formed in substantially the same shape as outer wall 22, having opening 31 therethrough where heating element 58 (discussed below) is inserted. The similarity in shape between central chamber 30 and outer wall 22 allows heating element 58 to convey consistent and even heat out of central chamber 30, and towards inner surface 23 of outer wall 22. Reaction chamber 24 comprises the open area between central chamber 30, and inner surface 23 of outer wall 22.

Bromine receiving means 36 is shown in FIG. 1 as comprising inlet stream coupling 38. Inlet stream coupling 38 is formed by the space between threaded flange 26 and wall flange 28 of housing 20. This space is also called ring space 40. Ring space 40 allows access to reaction chamber 24 through inlet stream coupling 38 by allowing bromine to flow into ring space 40, down inner surface 23 of outer wall 22, and into at least one flow channel 50.

Hydrogen receiving means 42 is shown in FIG. 1 as comprising gap 44. In its preferred embodiment, recombinator 10 is surrounded by a substantially hydrogen-rich environment. Gap 44 provides access to reaction chamber 24, by exposing chamber 24 to the environment. In FIG. 1, gap 44 is shown as being located near the bottom ends of housing 20 and heating element 58. Additionally, FIG. 1 depicts gap 44 as being a single, isolated circumferential opening into reaction chamber 24. However, it is also contemplated that gap 44 could comprise a number of openings of various sizes and shapes, which could be located in outer wall 22, or in other portions of housing 20 or heating element 58.

As would be known by a person of ordinary skill in the art, hydrogen receiving means 42 could also comprise inlet stream coupling 38. While in operation, a flowing electrolyte zinc-bromine battery produces hydrogen at the zinc electrodes. This hydrogen is at least partially dissolved within the electrolyte of the system. Therefore, as the bromine-rich second phase is fed into inlet stream coupling 38, it carries with it at least a small amount of hydrogen. This hydrogen can also be utilized in the reacidification of the electrolyte stream. Similarly, the hydrogen produced in the stacks can be collected in a separate hydrogen tank, which can then be introduced into reaction chamber 24 through inlet stream coupling 38, or gap 44.

Delivery controlling means 48 is shown in FIG. 1 as comprising at least one flow channel 50. The at least one flow channel comprises one or more channels running in a helix-like design down inner surface 23 or outer wall 22. These channels are shown in cross-section in FIG. 1 in their preferred embodiment, with the at least one flow channel 50 making several revolutions around inner surface 23 of outer wall 22 before being exposed to reaction chamber 24. However, a steeper path may also be taken, reducing the residence time of any bromine that may be flowing down and through at least one flow channel 50. As was discussed above, channel 50 may additionally provide a means for securing threaded flange 26 to outer wall 22 of housing 20, by allowing threaded flange 26 to couple with channel 50 via a standard screw and thread design. However, as stated previously, securing threaded flange 26 to outer wall 22 cannot block channel 50 so that bromine cannot thereafter flow through channel 50.

Reacting means 52 is shown in FIG. 1 as comprising catalyst 54 and temperature control means 56. Reacting means 52 provides energy to reaction chamber 24 to help vaporize bromine that enters the chamber. Further, reacting means 52 provides the necessary precursors to help gaseous bromine and hydrogen to react to form hydrogen bromide.

Catalyst 54 is shown in FIG. 1 as a series of parallel lines surrounding central chamber 30. The parallel lines in FIG. 1 represent the preferred configuration of catalyst 54 as being substantially wrapped around central chamber 30 in a spiral-like fashion. Catalyst 54 is preferably made from platinized carbon cloth, with an area of approximately 40 cm², and an active surface area of greater than 1200 m²/g. Although the total area and surface area given are the preferred parameters of catalyst 54, any number of configurations or platinum loadings could similarly suffice, as long as the free movement of gaseous hydrogen and bromine is not inhibited. For example, in the preferred embodiment, such free movement is facilitated through the use of a cloth for catalyst 54. In order to additionally facilitate the movement of gasses, it is preferable to maintain some degree of spacing between the spirals of catalyst 54 through the use of spacers 55.

Temperature control means 56 is shown within central chamber 30 of housing 20 as additionally comprising cover 58, heating element 60, and base flange 68. During the operation of recombinator device 10, temperature control means 56 seals the top portion of reaction chamber 24, senses the current temperature of reaction chamber 24, and adjusts the temperature with reaction chamber 24 to a predetermined value. Further, temperature control means 56 provides a means for supporting catalyst 54 within reaction chamber 24.

Cover 58 seals the top of housing 20 using o-ring 59. As seen in FIG. 1, cover 58 fits securely inside of threaded flange 26, and completes the top seal of reaction chamber 24 with o-ring 59. Cover 58 may be constructed from any number of materials, but is preferably constructed from the same or similar materials as outer wall 22. O-ring 59 is preferably constructed from a flexible material (such as rubber) so as to help seal recombinator 10.

Heating element 60 generally comprises the central portion of temperature control means 56. Heating element 60 comprises heater 62 and temperature sensor 64, inserted within heating cartridge 66. Heater 62 is preferably a resistor, which creates heat by standard electrical resistance, heating up heater 62 and therefore the material surrounding heater 62. However, other forms of heat could also be used. Temperature sensor 64 detects the temperature of heater 62, as well as reaction chamber 24. Based on predetermined data, temperature sensor 64 can elect to alter the heating characteristics of heater 62 to maintain a predetermined temperature within reaction chamber 24. Heating cartridge 66 holds and secures heater 62 and temperature sensor 64 within central chamber 30. Heating cartridge 66 may be constructed from any rigid, heat conductive material, but is preferably constructed from an inexpensive material, as the heating element 60 may require replacement from time to time.

Base flange 68 is a flange extending perpendicularly outward from the bottom portion of heating cartridge 68. Base flange 68, along with the bottom end of outer wall 22, helps to define gap 44 discussed above. Further, base flange 68 is at least partially defined by base area 70, which forms a flat area immediately below central chamber 30. Base area provides a support means for catalyst 54, while remaining substantially apart from the bottom edge of inner surface 23 of outer wall 22. As will be discussed further below, this arrangement ensures that catalyst 54 remains dry and separate from any bromine that is not vaporized.

Distributing means 72 is shown in FIG. 1 as comprising gap 44. As discussed above, gap 44 is located near the bottom end of outer wall 22, and provides the environment access to reaction chamber 24. Unlike hydrogen receiving means 42, however, distributing means 72 should be located at the bottom end of outer wall 22, as that location allows liquid bromine to pass into the reaction chamber 24 through channel 50, to flow down inner surface 23 of outer wall 22, and to flow out of recombinator 10 through gap 44 in bottom.

Recombinator 10 can be used in association with gas handling unit 100, shown in FIG. 2, to reacidify an electrolyte stream in a flowing electrolyte zinc-bromine battery. Gas handling unit 100 comprises sealed gas chamber 110, bromine receiving means 120, hydrogen receiving means 124, reacting means 128, gas maintaining means 130, and distributing means 144. When properly situated, gas handling unit 100 allows for continuous operation of the zinc-bromine battery by ensuring constant pH within the electrolyte streams, while still allowing for operational irregularities such as improper or unpredictable gas production, or even irregular electrolyte flow due to gas production.

Sealed gas chamber 110 is shown in FIG. 2 as a generally rectangularly-shaped container having top side 112, walls 114, and bottom side 116 forming a sealed enclosure. The sealed enclosure is capable of holding a number of fluids, including gaseous hydrogen and bromine, as well as liquid bromine and hydrogen bromide. The shape of the container is not particularly important, as any shape having sufficient volume to contain an operational amount of zinc-bromine battery materials will suffice.

Bromine receiving means 120 is shown in FIG. 2 as comprising bromine stream coupling 122. Bromine stream coupling 122 provides a fluidic connection between sealed gas chamber 110 and the positive electrolyte loop of a zinc-bromine battery. Bromine stream coupling 122 allows the introduction of complexed bromine from the positive electrolyte loop into the sealed gas chamber 110.

Hydrogen receiving means 124 is shown in FIG. 2 as comprising a hydrogen stream coupling 126 connecting to the positive electrolyte loop of a zinc-bromine battery.

The bromine coupling 122 provides a fluidic connection between the positive electrolyte loop and the sealed gas chamber 110. For example, the positive electrolyte loop of the zinc-bromine battery may have gas collecting tubes on top of the battery stacks, and hydrogen coupling 126 can connect those tubes with sealed gas chamber 110. As is known, the battery stacks of a zinc-bromine battery also produce hydrogen that is dissolved in the electrolyte itself. In a preferred embodiment of the invention, hydrogen receiving means 124 additionally comprises bromine stream coupling 122, wherein hydrogen is introduced into sealed gas chamber 110 dissolved into or along with the complexed bromine phase.

Reacting means 128 is shown in FIG. 2 as comprising recombinator 10, described in detail above. As noted, recombinator 10 helps to vaporize incoming complexed bromine, and to react that bromine with present hydrogen to form hydrogen bromide. Recombinator 10 is therefore in fluidic communication with both the bromine receiving means 120 and the hydrogen receiving means 124. Specifically, as noted above, ring space 40 may receive both hydrogen and bromine from the positive electrolyte loop by placing reaction chamber 24 in fluidic communication with bromine stream coupling 122. Additionally, gap 44 also acts to introduce hydrogen into reaction chamber 24 from the surrounding environment in sealed gas chamber 110. Hydrogen stream coupling 126 introduces hydrogen into sealed gas chamber 110 from the positive electrolyte loop for use by recombinator 10.

Gas maintaining means 130 is shown in FIG. 2 as comprising pressure relieving means 132 and opening 140. Gas maintaining means 130 ensures that in all but the most extreme circumstances, all gas products, whether they are from the positive electrolyte loop, or from the vaporizing action of recombinator 10, are maintained in gas handling unit 100. Since resources within the closed system are limited, maintaining means 130 is extremely helpful to continuous, effective operation of the system.

Pressure relieving means 132 comprises pressure sensor 134, pressure valve 136, and filter apparatus 138. During operation of gas handling unit 100, pressure release means 134 ensures the operating pressure of gas handling unit 100 is maintained within predetermined limits, and if those limits are breached, enables the emergency release of gasses contained within sealed gas chamber 110 to the environment by pressure release valve 136.

Pressure sensor 134 is mounted on or near top side 112, walls 114, or bottom side 116 of gas handing unit 100, such that sensor 134 is in contact with the interior of sealed gas chamber 110. Pressure sensor 134 is in communication with pressure valve 136 in order to control the opening or closing of valve 136. Pressure valve 136 is located between sealed gas chamber 110, and opening 140. Pressure valve 136 substantially seals sealed gas chamber 110 from the surrounding environment.

Filter apparatus 138 is located between pressure valve 136 and opening 140 so that all gasses that could be released from sealed gas chamber 110 would pass through filter apparatus 138 before passing through opening 140 into the surrounding environment. Filter apparatus 138 is preferably comprised of a zinc powder suspended in a container such that the gas vented by pressure valve 136 can pass through and around the zinc powder. Other similar filters can also be used also. Filter apparatus 138 ensures that gaseous bromine is transferred into bromide (either in solution or as a salt) before release of the excess gas to the environment. After the bromine is converted into bromide in solution, or complexed bromide, it is maintained within filter 138 for later removal.

Opening 140 is a small (approximately 2 mm in diameter) opening in top side 112 of sealed gas chamber 110 which permits gas released from the interior of sealed gas chamber 110 to escape to the environment. Opening 140 is disclosed as having a relatively small diameter due to the need for secure sealing of sealed gas chamber 110. As is known by those of ordinary skill in the art, a zinc-bromine flowing electrolyte system depends upon a consistent, low pH. Variations in pH values cause performance problems in the battery, including formation of mossy zinc plating on the electrodes, as well as increased corrosion of the electrodes. In order to maintain the pH within the system, it is necessary to reacidify the streams using hydrogen produced at the zinc electrodes. If hydrogen escapes, for example through opening 140, it is no longer available for reacidification. Therefore, care must be taken to ensure containment of all gasses except in the most extreme circumstances.

Gas handling unit 100 is shown in FIG. 2 as additionally comprising liquid overflow containing means 142. Liquid overflow containing means 142 comprises a basin or similar container that is configured to receive overflow electrolyte from gas handling unit 100. Therefore, the container should be constructed from a material that is substantially non-reactive and stable relative to the components of a zinc-bromine battery system, including bromine, bromide, hydrogen bromine, zinc bromide, and hydrogen. The container 142 is shown in FIG. 2 as substantially surrounding filter apparatus near top side 112 of gas handling unit 100. However, the container 142 may additionally be placed in an external location relative to the sealed gas chamber 110, so long as it is in communication with the chamber 110.

Distributing means 144 is shown in FIG. 2 as comprising first conduit 148, and second conduit 150 extending into and through bottom side 116 of sealed gas chamber 110. First conduit 148 and second conduit 150 are tubes or pipes that connect sealed gas chamber 110 to the positive and negative electrolyte loops, respectively. As will be discussed in more detail in the operations section below, the complexed bromine phase passes into sealed gas chamber 110, and into recombinator 10 where at least some of the complexed bromine is vaporized from liquid to gas. Unvaporized bromine, however, passes through recombinator 10, and is collected in the bottom portion of gas handling unit. It is preferable that the complexed bromine is not introduced into the negative electrolyte loop of the zinc-bromine battery. Therefore, second conduit 150 also comprises means for preventing introduction of bromine. Preferably, this introduction preventing means comprises second conduit 150 extending into sealed gas chamber 110 a distance such that the level of liquid complexed bromine is below the top of second conduit 150. Thereafter, liquid complexed bromine should be able to flow into first conduit 148, but not second conduit 150.

In operation, a flowing electrolyte zinc-bromine battery is shown in FIG. 3, wherein the battery has a positive electrolyte loop, a negative electrolyte loop, a set of electrode stacks, and hydrogen collection pipes. The zinc-bromine battery produces electricity and occasionally hydrogen during the charge and discharge cycles, as well as forming a second layer of liquid within the electrolyte consisting of complexed bromine.

As the battery operates, it passes the generated electricity out of the battery to an external load. While the electricity is produced, the battery collects hydrogen in the hydrogen collection pipes, and accumulates complexed bromine within the positive electrolyte loop.

Complexed bromine is passed into sealed gas chamber 110 through bromine receiving means 120. Complexed bromine generally comprises Br₂, formed into a second phase within the electrolyte of the positive electrolyte loop of the battery, which is pumped out of the positive electrolyte loop and into bromine stream coupling 122 for introduction into gas handling unit 100. Simultaneously, hydrogen is passed into sealed gas chamber 110 through hydrogen receiving means 124 from the hydrogen collection pipes. However, complexed bromine may also contain certain amounts of hydrogen, dissolved within the bromine phase. Additionally, as complexed bromine is passed into sealed gas chamber 110 via bromine receiving means 120 it may also carry with it packets of hydrogen gas that are not dissolved, but instead are simply carried with the bromine flow.

The bromine and hydrogen components are introduced into sealed gas chamber 110. The complexed bromine stream is preferably fed to recombinator 10 via ring space 40. From ring space 40, bromine flows into flow channel 50, through channel 50, and down inner surface 23 of outer wall 22 within reaction chamber 24. Reaction chamber 24 has already been brought up to reaction temperatures, between 80 and 130 degrees Celsius. As bromine flows through channels 50 and down inner surface 23, it is vaporized into gaseous bromine.

Simultaneously, hydrogen is introduced into recombinator 10. The hydrogen stream can be fed to sealed gas chamber 110 itself, and therefore to recombinator 10 directly through gap 44, or hydrogen may be introduced to recominbator 10 along with the complexed bromine stream through bromine stream coupling 38. In any case, hydrogen is present within reaction chamber 24 when the complexed bromine stream is vaporized.

Hydrogen and gaseous bromine naturally react to form hydrogen bromide. However, reaction chamber 24 includes catalyst 54 that helps to improve the conversion of the bromine/hydrogen reaction. Bromine gas and hydrogen gas flow through and around catalyst 54, reacting to form hydrogen bromide. The hydrogen bromide created, along with unreacted gaseous bromine and unvaporized bromine, pass out of recombinator 10 through gap 44 into sealed gas chamber 110.

Once in sealed gas chamber 110, gaseous components generally remain within sealed gas chamber 110, with the possibility that some gas may escape dissolved in electrolyte solution. The liquid components, including complexed bromine solution and hydrogen bromide, collect on bottom side 116 of sealed gas chamber 110. As discussed above, second conduit 150 extends into sealed gas chamber 110 above the liquid level in bottom 116 of sealed gas chamber 110, so no liquid should pass into the negative electrolyte loop. However, the collected liquid is allowed to enter the positive electrolyte loop through first conduit 148, reacidifying the electrolyte and maintaining the operation of the system.

Under certain circumstances, pressure relieving means 132 and liquid overflow containment means 142 may be required. For example, under certain circumstances, usually inefficient battery operation, an overabundance of gaseous products may be collected within sealed gas chamber 110. In that case, pressure sensor 134 detects the increase of pressure within sealed gas chamber 110, and opens pressure valve 136. The gaseous components within sealed gas chamber 110 are vented out of chamber 110, and through filter apparatus 138. As the gaseous components pass through filter apparatus 138, any gaseous bromine is complexed with zinc contained within filter apparatus 138, turning it into the complexed bromide species and maintaining the species within filter apparatus 138. Thereafter, the remaining gaseous components are vented out of opening 140 to the surrounding environment, substantially free of gaseous bromine, and therefore reducing any malodorous characteristics of the exiting gas.

In another similar situation where the battery stack is producing an excess amount of hydrogen, bubbles of hydrogen may push an inordinate amount of electrolyte out of the stack and into gas handling unit 100. In that case, the liquid level at bottom side 116 of sealed gas chamber 110 increases to the point where it is exposed to liquid overflow containment means 142. The excess liquid is collected in overflow container, where it can later be removed and processed. Preferably, if such an event occurs, overflow containment means 142 additionally includes a leakage sensor (not shown) capable of sensing such an overflow condition, and indicating the presence of overflow liquid to an outside system or controller for removal and/or correction of the battery conditions. Once removed, overflow liquid can be returned to the battery system.

The foregoing description merely explains and illustrates the invention and the invention is not limited thereto except insofar as the appended claims are so limited, as those skilled in the art who have the disclosure before them will be able to make modifications without departing the scope of the invention.

What is claimed is:

1. A recombinator, comprising:
a housing operatively associated with a zinc-bromine battery, wherein the housing comprises an outer wall that defines a reaction space therein;
means for introducing hydrogen into the reaction space from the zinc bromine battery;
means for introducing bromine into the reaction space from the zinc-bromine battery;
means for controlling the delivery of bromine into the reaction space, the delivery control means comprising at least one flow channel associated with the inner surface of the outer wall;
means for reacting the hydrogen and the bromine together so as to form hydrobromic acid; and
means for distributing the hydrobromic acid back into the zinc-bromine battery for the reacidification of same.

2. The device according to claim 1, wherein the at least one flow channel comprises a helix around the circumference of the inner surface of the outer wall.

3. The device according to claim 1, wherein the bromine receiving means comprises an inlet stream coupling operatively attached to the zinc-bromine battery.

4. The device according to claim 3, wherein the housing further comprises a threaded flange, and a wall flange, the inlet stream coupling comprises a ring space formed by the region between the threaded flange and the wall flange.

5. The device according to claim 1, wherein the hydrogen receiving means comprises a gap associated with the housing, wherein the gap exposes the reaction space to a hydrogen-rich environment.

6. The device according to claim 3, wherein the hydrogen receiving means also comprises the inlet stream coupling.

7. The device according to claim 1, wherein the distributing means comprises a gap associated with the housing.

8. The device according to claim 1, wherein the reacting means comprises a catalyst operatively placed within the reaction space.

9. The device according to claim 8, wherein the housing additionally comprises a central chamber having a base flange, and the catalyst is placed around the central chamber, and on top of the base flange.

10. The device according to claim 8, wherein the catalyst comprises a platinized carbon cloth.

11. The device according to claim 10, wherein the cloth comprises an area of approximately 40 cm².

12. The device according to claim 1, wherein the reacting means comprises a means for controlling the temperature within the housing.

13. The device according to claim 12, wherein the temperature control means comprises a heating element in thermal contact with the reaction space.

14. The device according to claim 13, wherein the housing additionally comprises a central chamber, wherein the heating element is placed within the central chamber, and the reaction space is defined between the central chamber and the inner surface of the outer wall.

15. A gas handling unit for use with a flowing-electrolyte zinc-bromine battery having a positive electrolyte loop, a negative electrolyte loop, and electrode stacks, comprising:
a sealed gas chamber;
means for receiving hydrogen into the sealed gas chamber from one of the positive and the negative electrolyte loops;
means for receiving bromine into the sealed gas chamber from one of the positive and the negative electrolyte loops;
means for reacting at least a portion of the hydrogen and bromine into hydrogen bromide;
means for maintaining gaseous products, including unreacted hydrogen, within the sealed gas chamber; and
means for distributing the hydrogen bromide and the unreacted bromine back to at least one of the positive and the negative electrolyte loops for the reacidification of same.

16. The device according to claim 15, wherein the hydrogen receiving means comprises an inlet stream coupling associated with at least one of the positive and negative electrolyte loops.

17. The device according to claim 15, wherein the electrode stack comprises an hydrogen accumulation reservoir, wherein the hydrogen receiving means comprises an inlet stream coupling associated with the hydrogen accumulation reservoir.

18. The device according to claim 15, wherein the bromine receiving means comprises an inlet stream coupling associated with at least one of the positive and negative electrolyte loops.

19. The device according to claim 18, wherein the reacting means comprises a recombinator in operatively associated with the inlet stream coupling, wherein the recombinator comprises:
a housing, wherein the housing comprises an outer wall that defines a reaction space therein;
means for introducing hydrogen into the reaction space;
means for introducing bromine into the reaction space;
means for controlling the delivery of bromine into the reaction space;
means for reacting the hydrogen and the bromine together so as to form hydrobromic acid; and
means for distributing the hydrobromic acid into the gas handling unit for the reacidification of an electrolyte stream therein.

20. The device of claim 15, wherein the maintaining means comprises a means for relieving excess pressure within the gas handling unit.

21. The device of claim 20, wherein the pressure relief means comprises a pressure release valve, and a pressure sensor associated with the pressure release valve, such that upon the occurrence of a predetermined condition, the pressure sensor activates the pressure release valve, venting at least a portion of the gaseous contents within the gas handling unit.

22. The device according to claim 21, wherein the pressure relief means additionally comprises a filter apparatus associated with the pressure release valve such that vented gaseous contents pass through the filter apparatus before being released from the gas handling unit.

23. The device according to claim 22, wherein the filter apparatus a zinc filter.

24. The device according to claim 15, wherein the gas handling unit additionally comprises means for containing liquid overflow.

25. The device according to claim 24, wherein the overflow containing means comprises an overflow container associated with the gas handling unit, such that upon the occurrence of the predetermined condition, excess liquid contained within the gas handling unit is introduced into the overflow container for later removal.

26. The device according to claim 15, wherein the distributing means comprises a first conduit and a second conduit, wherein the first conduit provides a fluidic connection between the gas handling unit and the positive electrolyte loop, and the second conduit provides a fluidic connection between the gas handling unit and the negative electrolyte loop.

27. The device according to claim 26 additionally comprises means for preventing the introduction of bromine into the second conduit.

28. The device according to claim 27, wherein the gas handling preventing means comprises the second conduit extending further into the sealed gas chamber relative to the first conduit.

29. A method for re-acidifying an electrolyte in a flowing electrolyte zinc-bromine battery, comprising the steps of:
introducing hydrogen into a reaction chamber;
introducing an electrolyte stream at least partially comprising aqueous bromine into the reaction chamber;
controlling the delivery of the electrolyte stream into the reaction chamber in such a way so as to increase the residence time of the electrolyte stream within the reaction chamber;
reacting the bromine with the hydrogen to create a reaction product;
reintegrating the reaction product with at least one of an electrolyte stream or an electrolyte reservoir of the zinc-bromine batter for reacidification of same.

30. The method according to claim 29, wherein the step of controlling comprises the step of allowing the electrolyte stream to flow down and through at least one flow channel associated with the reaction chamber.

31. The method according to claim 30, wherein the at least one flow channel comprises at least one flow channel in the shape of a helix.

32. The method according to claim 39, wherein the method further includes the step of regulating the temperature of the reaction chamber.

33. The method according to claim 32, wherein the step of regulating the temperature further includes the steps of:
pre-heating the reaction chamber; and
maintaining the temperature within the reaction chamber;

34. The method according to claim 33, wherein:
the step of pre-heating comprises the step of adjusting the temperature of the reaction chamber to between approximately 100 degrees Celsius and approximately 120 degrees Celsius; and
the step of maintaining the temperature of the reaction chamber comprises the step of maintaining the temperature between approximately 100 degrees Celsius and approximately 120 degrees Celsius.

35. The method according to claim 29 wherein the step of reintegrating the reaction product further includes the step of removing the reaction produce and excess reactants through a gap in the reaction chamber.

36. The method according to claim 29, wherein the step of reacting the aqueous bromine and hydrogen includes the step of associating the same with a catalyst.

37. The method according to claim 36, wherein the catalyst comprises at least one of a platinized carbon cloth, and heat.
